(19) United States
(12) Patent Application Publication
(10) Pub. No.: US 2003/0226050 A1
(43) Pub. Date: Dec. 4, 2003

(54) Power saving for mac ethernet control logic

(76) Inventors: James Ching-Shau Yik, Mission Viejo, CA (US); Linghsiao Wang, Tustin, CA (US)

Correspondence Address: BAKER + HOSTETLER LLP, WASHINGTON SQUARE, SUITE 1100, 1050 CONNECTICUT AVE. N.W., WASHINGTON, DC, 20036-5304, US

(21) Appl. No.: 10/168,706

(22) PCT Filed: Dec. 18, 2000
(86) PCT No.: PCT/US00/34344

(51) Int. Cl. G06F 1/26

(52) U.S. Cl. 713/324

(57) ABSTRACT

A media access controller (100) having a power-saving feature. The controller (100) comprises a receive logic circuit for receiving incoming data from a physical interface device (104) and processing the incoming data for transmission to a frame processor (102), and a transmit logic circuit for receiving outgoing data of the frame processor (102) and processing the outgoing data for transmission to the physical interface device (104). A power management control logic (114) operatively connects to each of the receive logic circuit and the transmit logic circuit to control the receive logic circuit and the transmit logic circuit in a first mode or a second mode. The power management control logic (114) controls the media access controller (100) in the first mode to conserve power by stopping operation of substantial portions of both the receive and transmit logic circuits, and in the second mode, which is a full power mode, by running both the receive and transmit logic circuits.

### TECHNICAL FIELD OF THE INVENTION

This invention is related to media access controllers, and more specifically, to a method of implementing a power saving feature in a media access controller by placing one or more clocks of the controller in an idle mode during times of low packet activity.

### BACKGROUND OF THE ART

The Internet has brought a significant number of commercial interests online in order to tap an enormous source of potential customers. Billions of dollars are being invested on hardware, software, and infrastructure to further this potential market bonanza. The infrastructure hardware comprises routers and switches for redirecting data packets through the maze of data networks so that the manufacturer can reach the customer, and vice versa. When these data networks fail due to hardware failure, or any number of other causes, the cost to both the customer and the manufacturer can be significant.

A primary cause of hardware failure is heat. As data transmission speeds increase, so does the amount of power required to process that data. Most high speed microprocessors are now being shipped with cooling fans to keep the device from burning up from the stress of processing an ever-increasing amount of data. However, other devices must be in place to get that data to and from the Internet or local network.

With Gigabit Ethernet just around the corner, network interface devices will now be stressed more heavily with the increased data flow, and the use of mechanical cooling methods can be problematic. A power-saving architecture is needed to extend the lifetime of these devices by providing more efficient power consumption.

### SUMMARY OF THE INVENTION

The present invention disclosed and claimed herein, in one aspect thereof, comprises a media access controller having a power-saving feature The controller comprises a receive logic circuit for receiving incoming data from a physical interface device and processing the incoming data for transmission to a frame processor, and a transmit logic circuit for receiving outgoing data of the frame processor and processing the outgoing data for transmission to the physical interface device. A power management control logic operatively connects to each of the receive logic circuit and the transmit logic circuit to control the receive logic circuit and the transmit logic circuit in a first mode or a second mode. The power management control logic controls the media access controller in the first mode to conserve power by stopping operation of substantial portions of both the receive and transmit logic circuits, and in the second mode, which is a full power mode, by running both the receive and transmit logic circuits.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates a block diagram of a disclosed embodiment;

FIG. 2 illustrates a flow chart of general event-activity processing, according to a disclosed embodiment;

FIG. 3 illustrates a more detailed flow chart of the power saving feature in accordance with a receive event;

FIG. 4 illustrates a more detailed flow chart of the power saving feature in accordance with a transmit event;

FIG. 5 illustrates a block diagram of the clock sources when using a variety of media independent interfaces;

FIG. 6 illustrates a gate diagram of an RMII implementation, according to the disclosed novel embodiments; and

FIG. 7 illustrates a system block diagram having a plurality of power-saving MAC controllers.

### DETAILED DESCRIPTION OF THE INVENTION

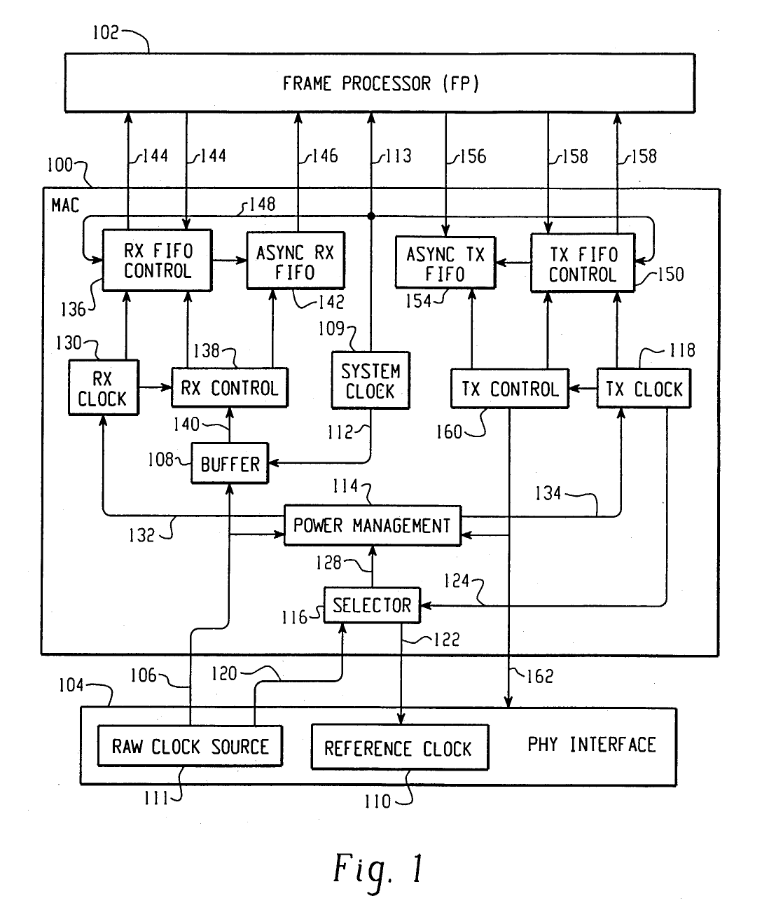

FIG. 1 illustrates a general block diagram of a MAC controller 100 and general interface connections therefrom to both a frame processor (FP) 102 and a physical (PHY) interface 104. The MAC controller 100 processes basic data flow between the FP 102 and the PHY interface 104. In general, and when initially in a power-savings (or idle) mode, the MAC controller 100 is placed in full operation (or run mode) in response to one or more detected “events.” Both the receive logic and the transmit logic of the MAC controller 100 are activated in response to the detection of either a receive event or a transmit event. Similarly, both the receive logic and the transmit logic are placed in the power-savings mode when neither a receive event nor a transmit event is detected. Therefore, and when initially in a power-savings mode, the detection of incoming packets by the MAC controller 100 from either of the FP 102 or the PHY interface 104 causes the MAC controller 100 to be transitioned from a power-savings mode to a fully operational mode.

The receive portion of the MAC controller 100, in this disclosed embodiment, will be discussed from the perspective of the data being received from the physical interface 104 through the MAC controller 100 to the FP 102, and with the MAC controller 100 starting from an initial idle state. In order to process incoming data from the PHY interface 104 to the FP 102, the MAC controller 100 must transition from the power-savings mode to the run mode. This operational transition occurs in response to an event signal from the PHY interface 104. In response to this event signal, the MAC controller 100 initiates a corresponding “activity,” and completes this activity before determining whether to transition back to the idle state. This event signal is the carrier sense signal of the PHY interface 104 used in accordance with common protocols such CSMA/CA (Carrier Sense Multiple Access/Collision Avoidance) and CSMA/CD (Carrier Sense Multiple Access/Collision detection). (Notably, where these LAN protocols are not used, the system of the disclosed embodiment can be used in conjunction with other protocols that provide signals which indicate that communication activity on the LAN or communication medium has been initiated and that data packets are forthcoming.) The carrier sense signal is placed on the network medium by a transmitting network device as a prelude to sending data packets, and is detected by the PHY interface 104, resulting in a corresponding signal being sent across one or more receive interface lines 106 from the PHY interface 104 to the MAC controller 100. The receive PHY interface lines 106 accommodate data and control signals between the MAC controller 100 and the PHY interface 104.

Prior to the portions of the receive logic of the MAC controller 100 “waking up” in response to the carrier sense signal, data may already be received into a buffer 108. The buffer 108 is operational at all times (as it receives pulses from a continuously-running system clock 109) and functions to temporarily hold the incoming data packets from the PHY interface 104 until the receive logic of the MAC controller 100 transitions from the power-saving mode to the fully operational run mode (e.g., in one or two clock signals). The buffer 108 comprises a series of pipelined flip-flops (not shown) which provide sufficient buffering action until the receive logic becomes fully operational, and then passes the data to internal receive control logic of the MAC controller 100 for processing. The buffer 108 connects to the system clock 109 over one or more clock lines 112, which system clock 109 is onboard the MAC controller 100 and runs continuously to keep the buffer 108 active at all times to receive incoming data packets from the PHY interface 104. The system clock also drive portions of logic of the FP 102, and connects thereto across FP system clock lines 113.

A power management logic block 114 embodied in the MAC controller 100 is employed to perform the power-saving function, and connects to one or more of the receive PHY interface lines 106 to sense the carrier sense event signal of the PHY interface 104. In response thereto, the power management logic 114 performs the function of waking-up the required logic functions of the MAC controller 100 (i.e., from the idle mode to run mode). More specifically, the power management logic 114 is operational at all times, and receives clock pulses from one or more clock sources depending upon the type of PHY interface 104 utilized. Selector logic 116 (e.g., a multiplexer) connects to select the appropriate clock source corresponding to the particular type of interface used. For example, where an RMII (Reduced Media Independent Interface) is used, the reference clock 110 of the PHY interface 104 is utilized to drive the internal TX CLK 118 and RX CLK 130. If an MII or GPSI (General Purpose Serial Interface, which is a 7-bit interface) implementation, a raw clock source 111 is used, which raw signals are both raw TX clock signals and raw RX clock signals from the PHY interface 104. The raw TX clock signals drive the TX CLK 118 and the raw RX clock signal drives the RX CLK 130. The TX CLK 118 is used as the source clock in the MII or GPSI implementation, since it more closely follows the raw TX clock signals. The system clock 109 could be used, however, it would require more synchronizer logic, and there is a potential for more latency between the time of the detected event and the time that the MAC logic 100 starts functioning. If an SMII (Serial MII), or GMII (Gigabit MII) or XGMII (Extended GMII) implementation is utilized, the reference clock 110 and the raw RX clock portion of the raw clock source 111 are utilized. The reference clock signal is used to generate the TX clock out signal directed back to the PHY interface 104, and also generates the TX CLK for the MAC control logic 100. When using the additional clock signals (the reference clock 110 and the raw clock source 111) the control logic can become more complex in order to synchronize the signals between the clock sources (110 and 111). The selector 116 connects to the external PHY reference clock 110 across one or more clock lines 122, the raw clock source 111 across one or more clock lines 120, and an onboard transmit clock (TX CLK) 118 across one or more clock lines 124. The output of the selector 116 connects to the power management logic 114 across one or more clock lines 128. The selector 116 may be implemented to operate independently to select the clock source corresponding to the particular type of PHY interface 104 utilized, or may also be operated dependently from the power management logic 114 (interconnect lines not shown) such that if the power management logic 114 senses the type of PHY interface 104, the selector 116 will be controlled to select the appropriate clocking source.

The wake-up function in the receive portion of the power management logic 114 is performed by gating both a gated receive clock (RX CLK) 130 across receive one or more clock control lines 132, and the TX CLK 118 across one or more clock lines 134. The RX CLK 130 provides clock signals to both a receive FIFO control block (RX FIFO Control) 136 and a receive control logic block (RX Control) 138. The RX Control logic 138, which receives data from the buffer 108 across buffer interface lines 140, formats the data for insertion into an asynchronous receive FIFO (Async RX FIFO) 142, and checks the status and integrity of the data. The RX Control logic 138 also interfaces to the RX FIFO Control logic 136 to provide control signals thereto. In response to the control signals received from the RX Control logic 136, the RX FIFO Control logic 136 synchronizes data input to the Async RX FIFO 142 via the RX Control logic 138.

Control of the data being passed from the Async RX FIFO 142 to the FP 102 is coordinated across control interface lines 144 between the RX FIFO Control 136 of the MAC controller 100 to the FP 102. Data is passed along one or more receive data interface lines 146 from the Async RX FIFO 142 of the MAC controller 100 to the FP 102. Both the RX CLK 130 and the TX CLK 118 are turned off when the power management logic 114 makes a determination that all activities related to both the receive and transmit operations on the MAC control logic 100 have been completed. However, since the Async RX FIFO 142 is asynchronous, it may continue to operate cooperatively with the FP 102 until the FP 102 has read the end-of-frame data, and the Async RX FIFO 142 has signaled that it is empty.

When acting as the clock source, the reference clock 110 also provides timing pulses to a small portion of the RX FIFO Control logic 136 across one or more clocking lines 148, a small portion of a transmit FIFO control logic (TX FIFO Control) 150 over the clocking lines 152, and a few registers of both the Async RX FIFO 142 and an asynchronous transmit FIFO (Async TX FIFO) 154 (the clock lines not shown for the latter two sets of logic).

The transmit logic of the MAC controller 100 operates to receive “outgoing” data from the FP 102, and processes it for transmission onto the PHY interface 104. The FP 102 sends a transmit signal to the transmit logic of the MAC controller 100 when the FP 102 is about to commence the transmission of frame packets to the PHY interface 104. This transmit signal is perceived by the power management logic 114 as a second type of event. In response to this second event signal, the power management logic 114 wakes-up the transmit logic of the MAC controller 100 by gating the gated TX CLK 118. Additionally, in response thereto, a second activity is initiated-the general process of preparing and transmitting packets from the FP 102 to the physical interface 104. This second activity includes outputting data to the Async TX FIFO 154 of the MAC controller 100 across one or more transmit interface lines 156, and coordinating this data transfer by communicating control signals between the MAC controller 100 and the FP 102 across one or more FP transmit control interface lines 158 to the TX FIFO Control logic 150. Data packet transmission timing is provided by the gated TX CLK 118 which receives start and stop signals across one or more transmit clock lines 134 from the power management block 114. The TX CLK 118 provides timing signals to both the TX FIFO Control logic 150 and a transmit control logic block (TX Control) 160. The TX Control logic 160 provides the data pathway from the Async TX FIFO 154 across physical interface transmit lines 162 to the PHY interface 104, and the control signals to the TX FIFO Control logic 150 to synchronize data insertion into the Async TX FIFO 154 from the FP 102. Control signals from the TX Control logic 160 also communicate data transmit status to the power management logic 114. Both the RX CLK 130 and the TX CLK 118 are implemented to match the ethernet receive and transmit rates, respectively. The second activity (transmit) ends when frame transmission from the FP 102 ends. Methods for determining when this occurs are when the interframe gap time exceeds a predefined limit, and the Async TX FIFO 154 is empty.

As indicated hereinabove, in order to maximize the power-saving benefits, the MAC controller 100 utilizes independent clock domains. Since the RX/TX FIFOs (142 and 154, respectively) are asynchronous, and control of the RX/TX Clock logic (130 and 118, respectively) is gated, a substantial portion of the logic of the MAC controller 100 can be placed in idle mode (i.e., stopped). When a valid link is detected between the MAC controller 100 and the PHY interface 104, the disclosed power saving method saves power by shutting down during the idle times which occur between extended packet transmissions. Whereas some conventional implementations rely on a link pulse to determine when to employ a power saving technique, the disclosed architecture embraces a more robust application which triggers on the extended absence of data packets being either received or transmitted, representing a significant reduction in power consumption of the MAC circuits. For example, a GIGA ethernet MAC controller operates at a high system speed of 125 MHz, which high speed has an impact on chip lifetime, this lifetime impacted by runtime power consumption and implemented cooling mechanisms. The capability of selectively shutting down portions of the MAC controller 100 during low packet activity prolongs the life of the MAC circuits without impacting packet throughput. The disclosed architecture is also applicable to 10G ethernet.

The disclosed embodiment provides a power savings method whereby the power management logic 114 of the MAC controller 100 turns both the RX CLK 130 and the TX CLK 118 on together in response to a detected event and then turns both of the clocks (RX CLK 130 and TX CLK 118) off in unison when no more activities are being processed. It can be appreciated that in an alternative embodiment, the power management logic 114 could be implemented to control the RX CLK 130 and TX CLK 118 independently, such that the RX CLK 130 and its associated receive logic can be operating to process incoming packet data from the PHY interface 104 while the TX CLK 118 and its associated transmit logic is idle (i.e., no data is available for processing from the FP 102 to the PHY interface 104). Similarly, the RX CLK 130 and its associated receive logic could be placed in idle mode due to the lack of incoming packets, while the TX CLK 118 and its associated transmit logic is in run mode to process packets for transmission to the PHY interface 104. Lastly, both the receive and transmit portions could be simultaneously in idle mode or in run mode, as in the embodiment disclosed hereinabove.

Note that with CSMA/CD implementations, the transmitting side also needs to monitor packet activity on the network medium to determine the time for packet transmission. This is required in half-duplex environments to determine the minimum interframe gap time. The transmission-side monitoring of the network packet activity is not required in full duplex ethernet systems. Therefore, a more robust logic design includes three capabilities: RX-driven events on the receive logic of the MAC controller 100, TX-driven events on the transmit logic of the MAC controller 100, and RX/TX-driven events which are part of the logic which monitors the network medium for packet activity (in CSMA/CD implementations). The RX/TX-driven events can be driven by only the TX event when in a full duplex regime.

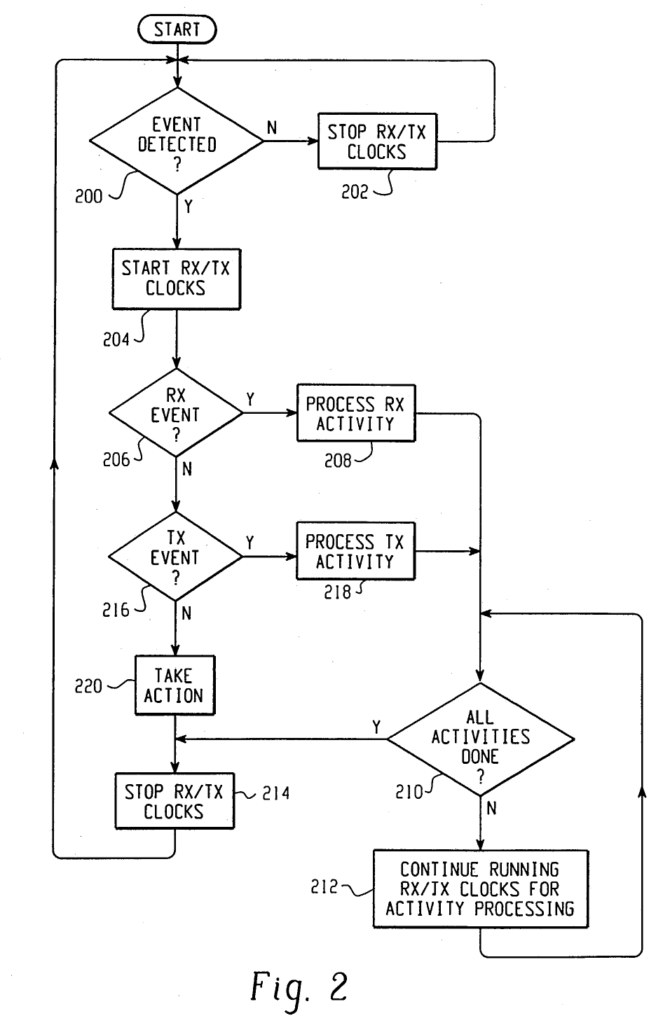

FIG. 2 illustrates a flow chart of the general aspects of a preferred embodiment. Discussion of the general process begins with the assumption that the system is operating in an idle state (i.e., the power management logic 114 has both the RX CLK 130 and the TX CLK 118 of the MAC controller 100 in a stopped mode). Flow begins at a Start block, and moves to a decision block 200 to determine if a predefined event has occurred. The number of events which can be detected is limited only by the discretion of the designer of the MAC controller 100. If not, flow is out the “N” path to a function block 202 where both the RX CLK 130 and the TX CLK 138 are maintained in a stop mode, which stop mode disables the functioning of a substantial portion of all circuits of the MAC controller 100. Flow is then from the function block 202 back to the input of the decision block 200 to continue sensing for the occurrence of an event. On the other hand, if a predefined event has occurred, flow is out the “Y” path of decision block 200 to a function block 204 to start the receive transmit clocks (130 and 118, respectively).

Flow continues to a decision block 206 to determine if the detected event was related to receiving data from the PHY interface 104. If so, flow is out the “Y” path to a function block 208 to begin processing the corresponding activities of that receive event. Flow continues to a decision block 210 to determine when those receive activities have been completed. If the activities have not been completed, flow is out the “N” path to a function block 212 to continue running the receive/transmit clocks (130 and 118) so that the activities can finish. The output of function block 212 then loops back to the input of decision block 210 to continue monitoring for the completion of all activities. If all receive/transmit activities have been completed, flow is out the “Y” path of decision block 210 to a function block 214 to stop the receive/transmit clocks (130 and 118) in order to place the MAC controller 100 in the power-savings mode.

If the event, as first detected in decision block 200, was not a receive event, flow is out the “N” path of decision block 206 to a decision block 216 to determine if the event is a transmit event. If so, flow is out the “Y” path to a function block 218 to begin processing the corresponding activity. Flow continues to the decision block 210 to determine if all activities are completed. Flow processing then continues in accordance to that which is described hereinabove. On the other hand, if the detected event was not a transmit event, flow is out the “N” path of decision block 216 to a 30 function block 220 to take action in accordance with a possible erroneous detection. This action may comprise sending a Resend Frame request, or entering a standby state, or setting a flag to indicate that a frame detection error occurred, or any other actions which may be employed. Flow is then to the function block 214 to stop both the RX CLK 130 and the TX CLK 118. Notably, the flow chart only depicts two events which can be detected. However, the disclosed method is not limited to two events, but may have more events which can be detected, at the discretion of the designer. After the clocks have been stopped, as indicated in function block 214, flow is back to the input of decision block 200 to continue monitoring for the occurrence of the receive/transmit events.

It can also be appreciated that the system is operable to detect multiple different events simultaneously. For example, a detected receive event can cause the MAC controller 100 to be placed in run mode. While in run mode, a transmit event from the FP 102 can be detected which also causes the power management logic 114 to maintain the receive/transmit clocks in run mode. The detection of both a receive event and a transmit event has the same net effect of starting of the receive/transmit clocks (130 and 118). Thus, it is possible that multiple events and corresponding activities could be processed simultaneously.

In operation, an event triggers an activity which completes one job. When an event is detected, the receive/transmit clocks (130 and 118) are started, and maintained through completion of the corresponding activity. Since a network communication transaction normally accommodates many frames per second (and perhaps in both directions), multiple transmit/receive events and activities may occur simultaneously. Therefore, before the receive/transmit clocks can be stopped due to the completion of one activity, a global check must be made to determine if other events or activities are still in-progress. If so, the clocks have to be maintained in run mode until all events and activities are complete. After all activities are complete, the clocks can be stopped (i.e., set back to idle mode) in order to save power, and to wait for another event.

The detectable events and corresponding activities for the MAC controller 100 logic, in this disclosed embodiment, are as follows. When the PHY interface 104 senses a carrier signal on the network medium, the power management logic 114 interprets this as an event which indicates frames are forthcoming. The corresponding activity performed by the MAC control logic 100 is to transfer the received frame(s) to the FP 102. The activity is complete when the FP 102 reads the end-of-frame (EOF) data from the Async RX FIFO 142. Another event occurs when the MAC control logic 100 receives a Frame Transmit request signal from the FP 102. The corresponding activity performed by the MAC control logic 100 is to process the packets for the FP 102 and transmit them to the PHY interface 104. The activity is complete when the frame has been transmitted, and the minimum interframe gap time has expired. The expiration of this time indicates that had another frame been following the first frame, that subsequent frame should have been present within the prescribed amount of time. If not, it is presumed that no frame is forthcoming. A further requirement which provides an indication that this activity has been completed is when the Async TX FIFO 154 is empty.

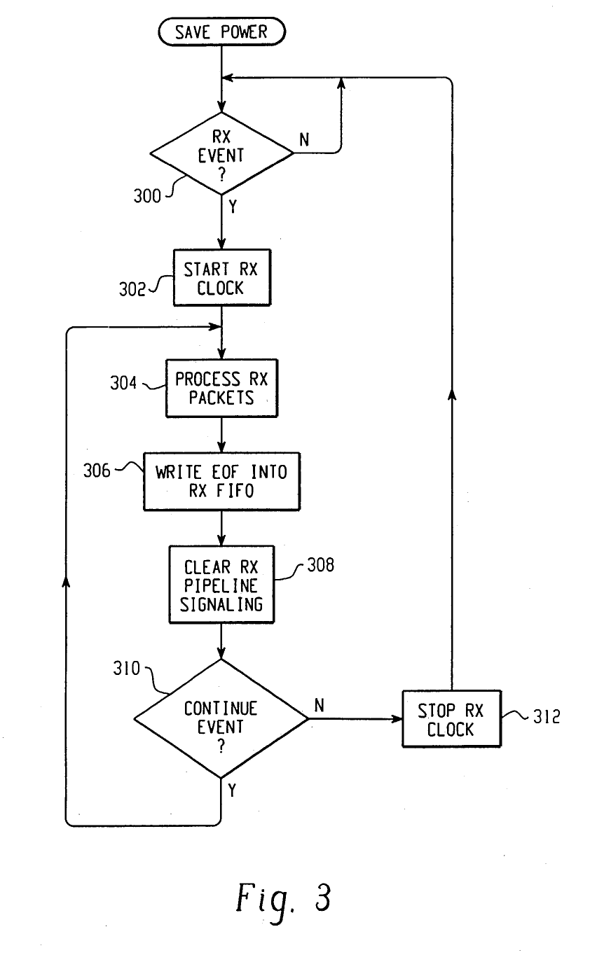

FIG. 3 illustrates a more detailed flow chart of the receive event and corresponding activities of the MAC controller 100, in accordance with the disclosed novel features. Discussion is premised on the assumption that the MAC controller is currently in an idle state. Flow begins at a starting point and moves to a decision block 300 to determine if a receive event has occurred, the receive event being the detection of a carrier sense signal from the PHY interface 104. If not, flow is out the “N” path and loops back to the input of decision block 300 to continue monitoring for the occurrence of the receive event. If an event has been detected, flow is out the “Y” path of decision block 300 to a function block 302 to start the RX CLK 110 (and the TX CLK 118). While the RX CLK 110 is being started, one or more data frames may have already arrived from the PHY interface 104 and been buffered into the buffer 108. Flow is then to a function block 304 where the received packets are processed by the receive logic of the MAC controller 100. This processing includes clocking the data into the RX Control logic 138 to check for data status and data integrity, and then formatting it for insertion into the Async RX FIFO 142. The MAC controller 100 then transmits the frames to the FP 102. This is accomplished by the RX FIFO Control 136 communicating with the FP 102 to coordinate frame transmission from the Asyne RX FIFO 142.

In order to detect completion of the activity for this receive event, at least two criteria must be met, 1) an end-of-frame (EOF) signal must be detected by the FP 102, and 2) the Asyne RX FIFO 142 must be empty. To this end, when packet processing is complete, flow is to a function block 306 to write EOF data into the Async RX FIFO 142, which EOF data is then detected by the FP 102. Flow is to a function block 308 to clear the receive pipeline signaling of the receive logic. Flow is then to a decision block 310 to determine if another receive event has been detected. If so, flow is out the “Y” path to the input of function block 304 to continue the packet processing cycle. If no more receive events are detected, flow is out the “N” path to a function block 312 to stop the RX CLK 130. However, as mentioned hereinabove, both the RX CLK 130 and the TX CLK 118 are operated together. Therefore, if a determination is made that the no more packets are being received from the PHY interface 104 such that the RX CLK 130 could be turned off, the power management logic 114 also performs a global activity check to ensure that no other activities are being performed before shutting down both clocks (130 and 118). If no other events or activities are being performed, both clocks (130 and 118) are stopped, and flow continues from the output of function block 312 to the input of decision block 300 to continue monitoring for receive events. The power management logic 114 monitors the processing of packets in both the receive logic and the transmit logic. The lack of packets to process in either the receive logic or the transmit logic triggers the power management logic 114 to perform a global check for any active events and activities prior to shutting down both of the clocks (130 and 118).

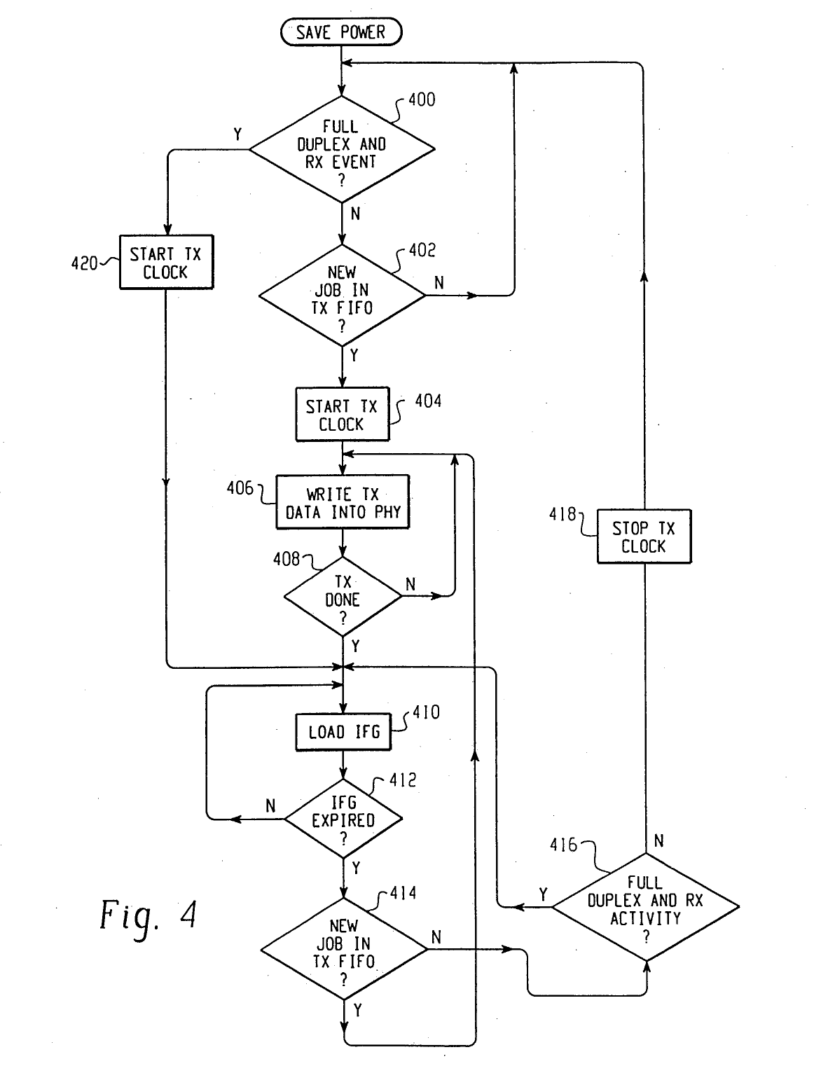

FIG. 4 illustrates a more detailed flow chart of the power saving feature in accordance with a transmit event. Flow begins at a starting point and continues to a decision block 400 to determine if full duplex operation is warranted by the presence of incoming receive data to the receive logic. Since the receive logic can be triggered into operation independent of the transmit logic, and vice versa, it can be appreciated that the transmit operation can be initiated without the receive logic being in full operation. Therefore decision block 400 tests for a receive event as well. If full duplex operation is not required since a receive event has not been detected, flow is out the “N” path of decision block 400 to another decision block 402 to determine if a new job has started in the Async TX FIFO 154. If no frame data has been written into the Async TX FIFO 154, flow is out the “N” path to the input of the decision block 400 to continue monitoring for any event (receive or transmit). The FP 102 begins the transmit process by writing start-of-frame data into the Async TX FIFO 154. When this is detected in decision block 402, flow is out the “Y” path to a function block 404 to start the TX CLK 118. By default, and as mentioned hereinabove, the RX CLK 130 is also started. Flow is then to a function block 406 where data processed from the FP 102 by the MAC controller 100 is written into the PHY interface 104. Flow continues to a decision block 408 to determine if the writing process is completed. If not, flow is out the “N” path to the input of the function block 406 to continue writing data into the PHY interface 104.

If the write process is complete, flow is out the “Y” path of decision block 408 to a function block 410 to measure and load the interframe gap (IFG) time into a register. Flow is then to a decision block 412 to determine of the IFG time has expired. Expiration of this time indicates that no more packets from the FP 102 are likely to follow, and that the transmit (or write) process to the PHY interface 104 can be discontinued. The IFG time is measured for each pair of frames being processed by the transmit logic. If the IFG time has not expired, flow is out the “N” path of decision block 412 to the input of function block 410 to continue measuring the IFG time and loading it into a register for the interrogation process. If the IFG time has expired in accordance with a predetermined value, flow is out the “Y” path of decision block 412 to another decision block 414 to determine if a new frame has been inserted into the Async TX FIFO 154. If so, flow is out the “Y” path to the input of function block 406 to begin the activity of processing the incoming frame data and writing it to the PHY interface 104. This process continues for each frame of data stuffed into the Async TX FIFO 154. If no new frame data has been inserted in to the Async TX FIFO 154, flow is out the “N” path of decision block 414 to a decision block 416 to again monitor the global processing of events and activities. If other events and activities are in-process, flow is out the “Y” path to the input of function block 410 to continue the process of measuring the IFG time. If no more events and activities are being processed, flow is out the “N” path to a function block 418 to stop the TX CLK 118. Flow is then back to the input of decision block 400 to begin the process over by monitoring for any events. If decision block 400 does detect an event, flow is out the “Y” path to a function block 420 to start the TX CLK 118. The output of function block 420 then flows to the input of function block 410 to commence the measurement and loading of the IFG time.

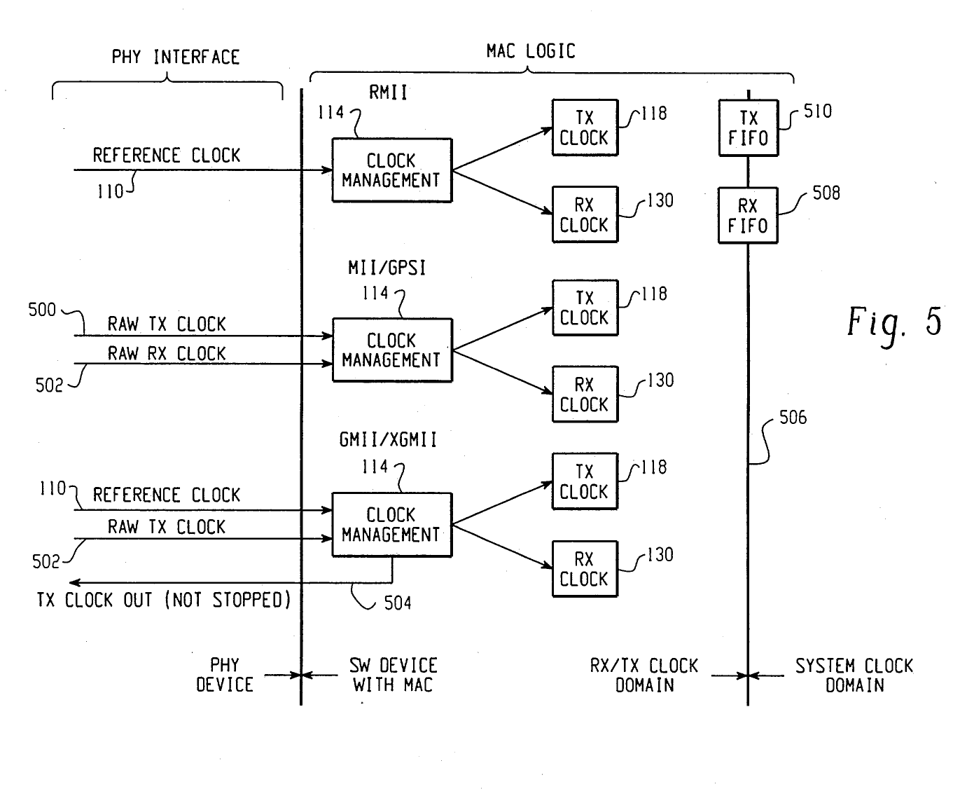

FIG. 5 illustrates a block diagram of the clock sources when using a variety of media independent interfaces. Where the interface is an RMII, the source clock for the power management logic 114 is the reference clock 110 from the PHY interface 104. Where the interface is an MII or GPSI, the source clock for the power management logic 114 is both the raw TX clock signals 500 and the raw RX clock signals 502 from the PHY interface device 104. Where the interface is, for example, a GMII or XGMII, the source clock pulses for the power management 114 are obtained from both the reference clock 110 and the raw RX clock signals 502 of the PHY interface 104. A transmit clock output 504, as controlled by the power management logic 114, is also routed back to the PHY interface 104, in the instance where the MII interface is either GMII or XGMII, and is not stopped. In any case, the power management logic 114 has control over both the RX CLK 130 and the TX CLK 118.

The clock domain line 506 indicates that the receive FIFO logic 508 and the transmit FIFO logic 510 are clocked by respective RX CLK 130 and TX CLCK 118 during operation, and that portions of both the receive and transmit logic circuits (508 and 510) receive pulses from the system clock 109.

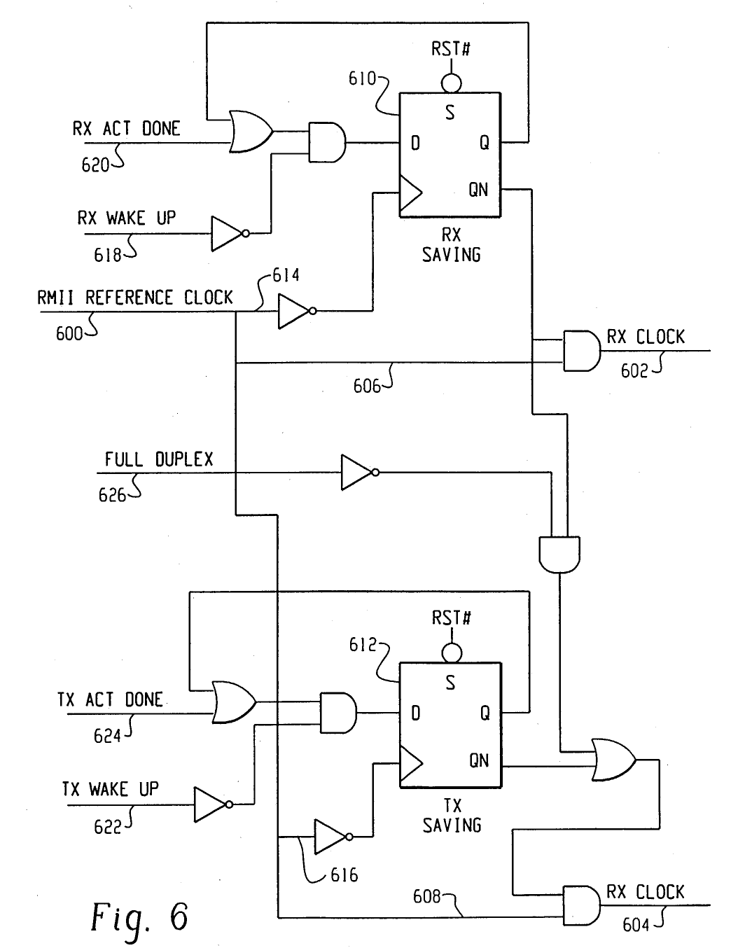

FIG. 6 illustrates a gate diagram of an RMII implementation, according to the disclosed novel embodiments. As mentioned hereinabove, the RMII reference clock signal 600 of the reference clock 110 is used as the clocking source for power management control in this device implementation. The RX CLK signal 602 and the TX CLK signal 604 are synchronized with the RMII reference clock signal 600 across respective clock lines 606 and 608. The RMII reference clock signal 600 also connects to clock a receive power saving flip-flop (RX Saving) 610 and transmit power saving flip-flop (TX Saving) 612 across respective clocking lines 614 and 616. Wake-up control signals for the RX Saving device 610 connect at a RX wake-up input 618, and the shutdown control input (RX act done) 620 provides shutdown control when no input packets are detected for processing receive activities from the PHY interface 104 to the FP 102. Similarly, the TX Saving device 612 has at a TX wake-up input 622 when for placing the transmit logic into run mode when a write frame signal is detected from the FP 102, and a shutdown control input (TX act done) 624 provides shutdown control when no input packets are detected for processing transmit activities from the FP 102 to the PHY interface 104. A full duplex input allows full duplex operation control where available.

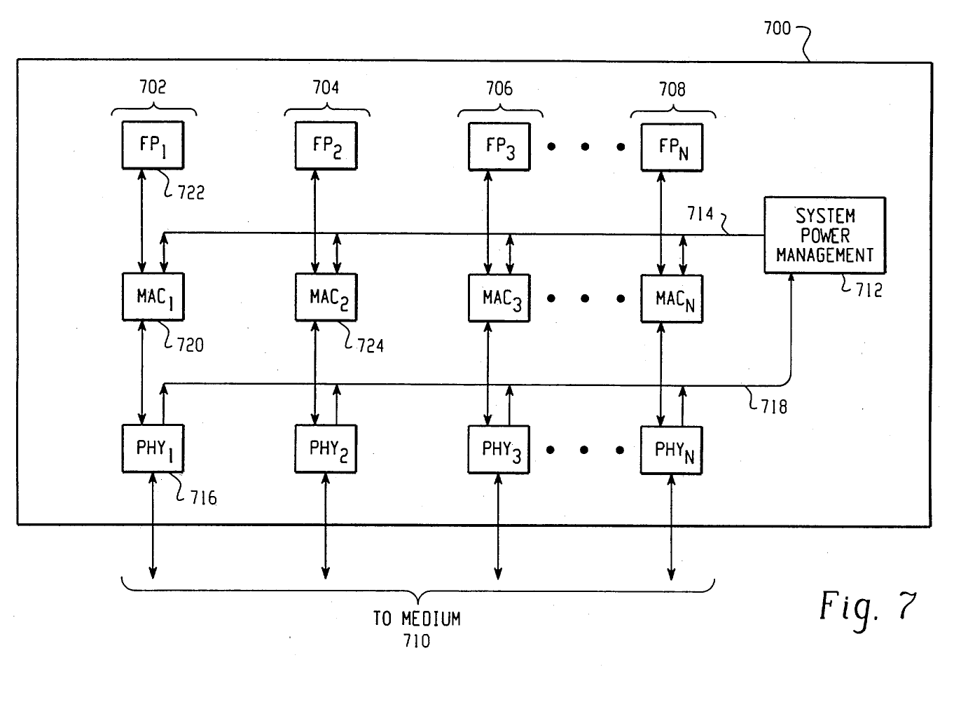

FIG. 7 illustrates a system block diagram utilizing multiple subsystems each operable to run in a power-saving mode. A system (e.g., a network switch) 600 contains multiple subsystems (702, 704, 706, and 708) which is common in network devices such as routers, switches, hub, etc., each of which comprises the power-saving features disclosed hereinabove. For example, the system 700 is operably disposed on a network medium 710 to route data traffic to one or more sub-networks (also called “subnets”), each distinct subnet associated with a respective one of the subsystems (702, 704, 706, or 708). The system 700 is configured with a central system power management controller 712, as shown, to control the gated clocks of each subsystem (702, 704, 706, and 708) over a subsystem data and control bus 714. In this particular embodiment, implementation of the system power management module 712 negates the need to implement a separate power management logic block 114 in each subsystem (702, 704, 706, and 708).

In operation, data frames placed on the medium are addressable to a predetermined subnet, requiring that only one of the subsystems (702, 704, 706, or 708) wake-up for processing of the data. For example, if data was placed on the medium 710 addressable to a first subnet in association with the first subsystem 702, a first subsystem physical interface 716 detects the carrier-sense signal and communicates the detection of that signal to the system power management logic 712 across a system PHY interface bus 718. The system power management logic 712 then gates a receive clock (not shown, but similar to RX CLK 110) of a MAC controller 720 of the first subsystem 702 to operate the receive logic (not shown, but similar to the receive logic RX Control 130, RX FIFO Control 136, and Async RX FIFO 142 disclosed hereinabove with respect to FIG. 1). The MAC controller 720 then signals its associated frame processor 722 that frame data is ready for frame processing, and transmits the data to the frame processor 722. Operation continues in the same manner for the transmit portion as that disclosed in FIG. 1, and for overall power-saving operation, in that the system management controller 712 may shutdown or run the gated receive/transmit clocks of the MAC controller 720 based upon the absence or presence of data.

As mentioned hereinabove with respect to the operation of the MAC controller 100 of FIG. 1, numerous events and activities can occur simultaneously. Similarly, in the disclosed system embodiment, not only are events and activities occurring simultaneously with a subsystem, but events and activities are occurring simultaneously relative to each subsystem (702, 704, 706, and 708). For example, while the receive/transmit logic of the MAC controller 720 of subsystem 702 may be placed in idle mode, the receive/transmit logic portion of a MAC controller 724 of subsystem 704 may be started in response to an event which requires operation of its receive logic. Therefore, different aspects of each subsystem may be in full-power operation while other portions of each subsystem are in the power-conservation mode.

In an alternative embodiment, the system 700 can omit the central system power management logic 712, since each subsystem (702, 704, 706, and 708) could contain its own separate power management logic, as disclosed hereinabove with respect to power management logic 114. Each subsystem module then operates independently in accordance with the predetermined events.

In a further alternative embodiment, the system contains both a central power management block 712, and separate power management blocks 114 for each subsystem (702, 704, 706, and 708) which operate cooperatively and in communication with each other to facilitate the disclosed power-savings features.

As indicated hereinabove, the disclosed novel features find application to many different kinds of physical interfaces. For example, this power-saving feature can be applied to the GPSI 7-bit interface, MII, RMII, SMII, and GMII interfaces. The MII is part of the Fast Ethernet specification, and replaces the 10Base-T ethernet's AUI (or Attachment Unit Interface). The MII is used to connect the MAC layer 100 to the PHY layer 104. RMII reduces the interface between the MAC controller 100 application specific integrated circuit and the transceiver from 16 to 7 pins per port, while the SMII further reduces the interface to just 2 pins per port.

Although the preferred embodiment has been described in detail, it should be understood that various changes, substitutions and alterations can be made therein without departing from the spirit and scope of the invention as defined by the appended claims.

What is claimed is:

1. A media access controller having a power-saving feature, comprising:
a receive logic circuit for receiving incoming data from a physical interface device and processing said incoming data for transmission to a frame processor;
a transmit logic circuit for receiving outgoing data of said frame processor and processing said outgoing data for transmission to said physical interface device; and
power management control logic operatively connected to each said receive logic circuit and said transmit logic circuit to control said receive logic circuit and said transmit logic circuit in a first mode or a second mode;
wherein said power management control logic controls the media access controller in said first mode to conserve power by stopping the operation of substantial portions of both of said receive and transmit logic circuits;
wherein said power management control logic controls the media access controller in said second mode, which is a full power mode, by running both said receive and transmit logic circuits.

2. The controller of claim 1, wherein said power management control logic controls one or more clocks of said receive and transmit logic circuits in response to the detection of an event signal.

3. The controller of claim 2, wherein said event signal is a carrier sense signal of said physical interface device which is detected by the media access controller.

4. The controller of claim 3, wherein said event signal is a carrier sense signal of said physical interface device which is detected by said power management control logic of the media access controller.

5. The controller of claim 4, wherein said power management control logic detects said carrier sense signal and runs a receive clock of said one or more clocks of said receive logic circuit in response to said carrier sense signal being detected.

6. The controller of claim 5, wherein said power management control logic detects said carrier sense signal and runs both a receive clock and a transmit clock of said one or more clocks of said receive logic circuit in response to said carrier sense signal being detected.

7. The controller of claim 2, wherein said event signal is a transmit signal which is communicated from said frame processor to the media access controller, which said transmit signal signals the media access controller that said outgoing data is forthcoming from said frame processor.

8. The controller of claim 7, wherein said power management control logic of the media access controller detects said transmit signal and runs a transmit clock of said transmit logic in response thereto.

9. The controller of claim 7, wherein said transmit signal is a start-writing-data signal which precedes the writing of data to said transmit logic of the media access controller.

10. The controller of claim 7, wherein said power management control logic of the media access controller detects said transmit signal and runs both a transmit clock of said transmit logic and a receive clock of said receive logic, in response thereto.

11. The controller of claim 2, wherein an activity is initiated in response to the detection of said event, said power management control logic monitors the processing of said activity and controls said receive and transmit logic circuits based upon the status of said activity.

12. The controller of claim 11, wherein said power management control logic places the media access controller in said power conservation mode when no activities are being processed by said receive and transmit logic circuits.

13. The controller of claim 11, wherein said power management control logic maintains the media access controller in said full power mode when at least one activity is being processed by said receive and transmit logic circuits.

14. The controller of claim 11, wherein said activity of said receive logic circuit comprises formatting, and checking the status and integrity of said incoming data prior to transmitting said incoming data to said frame processor.

15. The controller of claim 14, wherein said activity of said receive logic circuit terminates when an end-of-frame signal is written into a receive FIFO of said receive logic circuit.

16. The controller of claim 11, wherein said activity of said transmit logic circuit terminates when an interframe gap time exceeds a predetermined value.

17. The controller of claim 11, wherein said activity of said transmit logic circuit terminates when a transmit FIFO of said transmit logic circuit is empty.

18. The controller of claim 1, wherein said power management control logic receives clock pulses from one or more clock sources in accordance with a type of said physical interface device connected thereto.

19. The controller of claim 18, wherein one of said one or more clock sources is a reference clock of said physical interface device.

20. The controller of claim 18, wherein one of said one or more clock sources is a raw transmit/receive clock of said physical interface device.

21. The controller of claim 18, wherein one of said one or more clock sources a transmit clock of said transmit logic circuit.

22. A method of providing a power-saving feature in a media access controller, comprising the steps of:
receiving into a receive logic circuit of the media access controller incoming data from a physical interface device, and processing said incoming data for transmission to a frame processor;
transmitting outgoing data from said frame processor into a transmit logic circuit of the media access controller, and processing said outgoing data for transmission to said physical interface device; and
controlling each said receive logic circuit and said transmit logic circuit with a power management control logic operatively connected to control said receive logic circuit and said transmit logic circuit in a first mode or a second mode;
wherein said power management control logic controls the media access controller in said first mode to conserve power by stopping the operation of substantial portions of both of said receive and transmit logic circuits;
wherein said power management control logic controls the media access controller in said second mode, which is a fall power mode, by running both said receive and transmit logic circuits.

23. The method of claim 22, wherein said power management control logic in the step of controlling controls one or more clocks of said receive and transmit logic circuits in response to the detection of an event signal.

24. The method of claim 23, wherein said event signal is a carrier sense signal of said physical interface device which is detected by the media access controller.

25. The method of claim 24, wherein said event signal is a carrier sense signal of said physical interface device which is detected by said power management control logic of the media access controller.

26. The method of claim 25, wherein said power management control logic in the step of controlling detects said carrier sense signal and runs a receive clock of said one or more clocks of said receive logic circuit in response to said carrier sense signal being detected.

27. The method of claim 26, wherein said power management control logic in the step of controlling detects said carrier sense signal and runs both a receive clock and a transmit clock of said one or more clocks of said receive logic circuit in response to said carrier sense signal being detected.

28. The method of claim 23, wherein said event signal is a transmit signal which is communicated from said frame processor to the media access controller, which said transmit signal signals the media access controller that said outgoing data is forthcoming from said frame processor.

29. The method of claim 28, wherein said power management control logic in the step of controlling detects said transmit signal and runs a transmit clock of said transmit logic in response thereto.

30. The method of claim 28, wherein said transmit signal is a start-writing-data signal which precedes the writing of data to said transmit logic of the media access controller.

31. The method of claim 28, wherein said power management control logic in the step of controlling detects said transmit signal, and runs both a transmit clock of said transmit logic and a receive clock of said receive logic in response thereto.

32. The method of claim 23, wherein an activity is initiated in response to the detection of said event, said power management control logic monitors the processing of said activity and controls said receive and transmit logic circuits in the step of controlling based upon the status of said activity.

33. The method of claim 32, wherein said power management control logic places the media access controller in said power conservation mode in the step of controlling when no activities are being processed by said receive and transmit logic circuits.

34. The method of claim 32, wherein said power management control logic maintains the media access controller in said full power mode when at least one activity is being processed by said receive and transmit logic circuits.

35. The method of claim 32, wherein said activity of said receive logic circuit comprises formatting, and checking the status and integrity of said incoming data prior to transmitting said incoming data to said frame processor.

36. The method of claim 35, wherein said activity of said receive logic circuit terminates when an end-of-frame signal is written into a receive FIFO of said receive logic circuit.

37. The method of claim 32, wherein said activity of said transmit logic circuit terminates when an interframe gap time exceeds a predetermined value.

38. The method of claim 32, wherein said activity of said transmit logic circuit terminates when a transmit FIFO of said transmit logic circuit is empty.

39. The method of claim 22, wherein said power management control logic in the step of controlling receives clock pulses from one or more clock sources in accordance with a type of said physical interface device connected thereto.

40. The method of claim 39, wherein one of said one or more clock sources is a reference clock of said physical interface device.

41. The method of claim 39, wherein one of said one or more clock sources is a raw transmit/receive clock of said physical interface device.

42. The method of claim 39, wherein one of said one or more clock sources a transmit clock of said transmit logic circuit.

43. A system for saving power in a plurality of media access controllers, comprising:
a plurality of the media access controllers operatively connected to respective physical interface devices, each media access controller having,
a receive logic circuit for receiving incoming data from a respective said physical interface device and passing said incoming data to a frame processor; and
a transmit logic circuit for receiving outgoing data from said frame processor and transmitting said outgoing data to said respective physical interface device;
one or more frame processors operatively connected to said plurality of media access controllers for processing said incoming and outgoing data; and
power management control logic operatively connected to each said receive logic circuit and said transmit logic circuit for controlling the respective media access controller in either a first mode or a second mode;
wherein said power management control logic controls the respective media access controller in said first mode to conserve power by stopping the operation of a substantial portion of both said receive and transmit logic circuits;
wherein said power management control logic controls the respective media access controller in said second mode, which is a full power mode, by running both said receive and transmit logic circuits.

44. The system of claim 43, wherein said power management control logic operatively connects to said receive logic and said transmit logic of each media access controller to place selected ones of the plurality of media access controllers in either said first mode or said second mode in response to one or more detected events associated with said selected ones of the plurality of media access controllers.

45. The system of claim 44, wherein one of said detected events is a carrier sense signal of said physical interface device which is detected by said power management control logic.

46. The system of claim 44, wherein one of said detected events is a start-writing-data signal of said frame processor which is detected by said power management control logic.

47. The system of claim 43, wherein said power management control logic controls the respective media access controller in said second mode when one or more events corresponding to that media access controller are detected, and in said first mode when all activities of the respective media access controller which are associated with said one or more events, are no longer processing.
